(19) United States
(12) Patent Application Publication
(10) Pub. No.: US 2012/0187882 A1
(43) Pub. Date: Jul. 26, 2012

(54) METHODS AND SYSTEMS FOR CONTROLLING OPERATION OF AN ELECTRIC MOTOR

(76) Inventors: Jared D. Zumstein, Fort Wayne, IN (US); Stephen Zavodny, Fort Wayne, IN (US); Bala Sundaram Nauduri, Hyderabad (IN)

(21) Appl. No.: 13/011,498

(22) Filed: Jan. 21, 2011

(51) Int. Cl. H02P 1/04

(52) U.S. Cl. 318/484

(57) ABSTRACT

A motor control system for controlling an electronically controlled motor based at least partially on a signal from a motor timer is described. The system includes a motor controller coupled to the electronically controlled motor and configured to drive the electronically controlled motor and a control device coupled to the motor controller. The control device is configured to provide the motor controller with a first speed control signal corresponding to a first speed in response to a start signal from the motor timer, monitor a first length of time the first speed control signal is provided to the motor controller, and provide the motor controller with a second speed control signal corresponding to a second speed after a first predefined length of time.

### BACKGROUND OF THE INVENTION

The embodiments described herein relate generally to electric motors, and more specifically, to methods and systems for controlling the speed of an electric motor in an aquatic application.

One of many uses of an electric motor is to operate a pump, and in turn, move a fluid. Examples of aquatic applications for pumps include pools, spas, and hot tubs. Such applications include a basin or tub structure that holds a supply of water and a circulation pump system. For example, the circulation pump system may include a pump and a pump motor. The pump, in combination with the pump motor, facilitates water heating and/or filtering by removing water from the tub structure, through a heater and/or filter, and returning the water into the tub structure.

A common motor used in such pump systems is an alternating current (AC) induction motor, for example, a single-speed AC induction motor or a two-speed AC induction motor. The two-speed AC induction motor is configured to operate at a high speed and at a low speed. At the low speed, a rate of water flowing through the pump is decreased when compared to the motor operating at the high speed. The pump motor operating at low speed consumes less electrical power, although, cost savings from lower energy consumption may be offset because the pump system has to operate for a longer period of time at the low speed to circulate the same amount of water as the pump system at high speed.

Other types of motors may be included in a pump system, for example, electronically commutated motors (ECM). Examples of ECMs are brushless direct current (BLDC) motors, permanent magnet alternating current (PMAC) motors, and variable reluctance motors. Typically, these motors provide higher electrical efficiency than an AC induction motor. ECMs also facilitate variable speed operation of the pump system.

Therefore, replacing an AC induction motor in a pool, spa, or hot tub with an ECM typically will reduce the operating costs associated with heating and/or filtering the pool, spa, or hot tub. However, ECMs and AC induction motors are not interchangeable, due at least in part to differences between how ECMs and AC induction motors are powered and controlled. The speed at which a two-speed AC induction motor operates depends upon which of two inputs receives an electrical power. A voltage, for example, a 115 VAC or 230 VAC voltage, is provided to either a high speed power line or a low speed power line. The two-speed AC induction motor operates at a high speed when operating power is provided to the high speed power line, and to high speed coils, of the AC induction motor. The two-speed AC induction motor operates at a low speed when operating power is provided to the low speed power line, and to low speed coils, of the AC induction motor. In contrast, an ECM typically receives an operating power from a power source at a motor drive unit, and varies a speed of operation of the motor based on a low-voltage control signal.

Typically, a pumping application requires a certain volume of fluid be pumped per minute after an initial startup time period. In pool applications this is referred to as “turn-over.” A certain number of turn-overs are required to filter and/or condition the water prior to use, necessitating a high flow rate and requiring a high motor speed and energy consumption. After the initial turn-overs, maintaining a high flow rate typically is not required to maintain adequate water filtration and/or conditioning. However, typical applications that include a single-speed motor will continue to operate at the high flow rate for the duration of the pump's timed operation and consume excess power. Furthermore, variable speed motors will also continue to operate at the high flow rate if the system does not include a separate energy-saving timer.

### BRIEF DESCRIPTION OF THE INVENTION

In one aspect, a motor control system for controlling an electronically controlled motor based at least partially on a signal from a motor timer is provided. The system includes a motor controller coupled to the electronically controlled motor and configured to drive the electronically controlled motor and a control device coupled to the motor controller. The control device is configured to provide the motor controller with a first speed control signal corresponding to a first speed in response to a start signal from the induction motor timer, monitor a first length of time the first speed control signal is provided to the motor controller, and provide the motor controller with a second speed control signal corresponding to a second speed after a first predefined length of time.

In another aspect, a method for controlling operation of an electronically controlled variable speed motor coupled to a motor controller and a control device is provided. The control device includes a processing device and at least one input device and is coupled to a motor timer. The method includes receiving, at the control device, a start signal from the motor timer and providing the motor controller with a first speed control signal in response to the start signal. The method also includes monitoring a first length of time the first speed control signal is provided to the motor controller and providing the motor controller with a second speed control signal corresponding to a second speed after a first predefined length of time.

### BRIEF DESCRIPTION OF THE DRAWINGS

FIG. 1 is a block diagram of an exemplary embodiment of a motor control system.

FIG. 2 is a block diagram of the motor control system shown in FIG. 1.

FIG. 3 is a perspective view of an exemplary embodiment of the motor and the motor control system shown in FIGS. 1 and 2.

FIG. 4 is a flow chart of an exemplary method for controlling operation of an electronically controlled variable speed motor, for example, the motor shown in FIG. 3.

FIG. 5 is a flow chart of an exemplary method performed by a control device for controlling operation of an electronically controlled variable speed motor, for example, the motor shown in FIG. 3.

### DETAILED DESCRIPTION OF THE INVENTION

The methods and systems described herein facilitate an automatic reduction in the speed of a fluid moving device after a preset time period at a higher speed. The automatic reduction in speed reduces an expenditure of energy by the fluid moving device and therefore, increases an efficiency of the device.

Technical effects of the methods and systems described herein include at least one of: (a) receiving, at the control device, a start signal from a motor timer; (b) providing a motor controller with a first speed control signal in response to the start signal; (c) monitoring a first length of time the first speed control signal is provided to the motor controller; and (d) providing the motor controller with a second speed control signal corresponding to a second speed after a first predefined length of time.

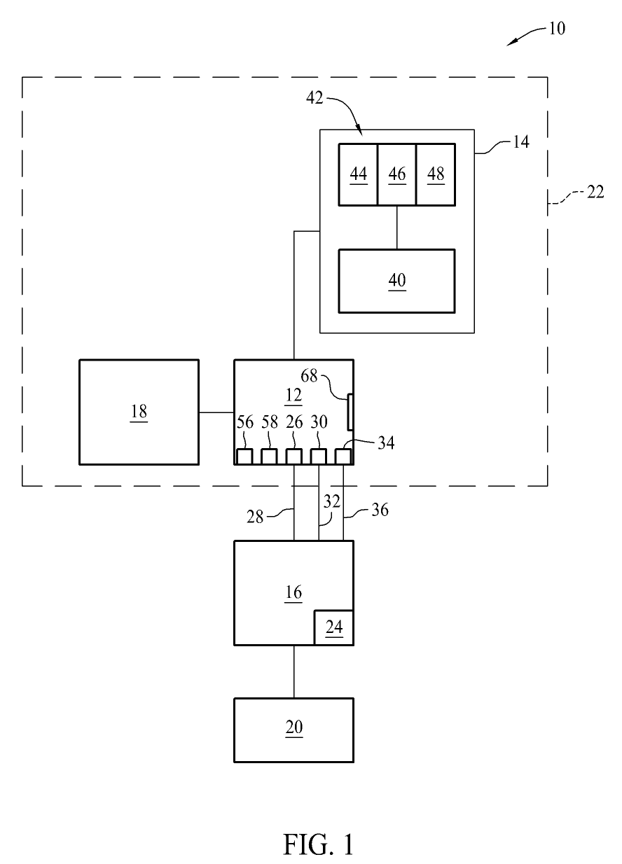

FIG. 1 is a block diagram of an exemplary embodiment of a motor control system 10. In the exemplary embodiment, motor control system 10 includes a motor controller 12 and a control device 14. In the exemplary embodiment, motor control system 10 is coupled to a single-speed motor timer 16. Motor controller 12 may also be referred to as a variable speed drive. Motor control system 10 is configured to power and control a motor 18. A power source 20 is coupled to timer 16. Power source 20 in aquatic applications is typically a supply of AC electric power, for example, 115 VAC or 230 VAC. Although described herein as separate, motor controller 12, control device 14, and/or motor 18 may be included within a motor system housing 22. For example, motor system housing 22 may at least partially enclose and protect motor controller 12, control device 14, and/or motor 18. In the exemplary embodiment, motor 18 is a brushless motor, for example, an electronically controlled variable speed motor, although, other types of motors may be included that allow motor control system 10 to function as described herein. Examples of an electronically controlled variable speed motor include a brushless direct current (BLDC) motor, a permanent magnet alternating current (PMAC) motor, and a variable reluctance motor. Electronically controlled variable speed motors may also be referred to herein as electronically commutated motors (ECMs).

In the exemplary embodiment, an alternating current (AC) induction motor included within an aquatic application such as a pool pump is replaced with motor 18. The methods and systems described herein facilitate replacing an induction motor with motor 18 and operating motor 18 using the same connections used to operate the induction motor. Such direct replacement of an induction motor with motor 18 minimizes costs associated with upgrading the motor because no additional electrical connections or physical structures are needed. In the exemplary embodiment, timer 16 is a single-speed timer. When coupled to an induction motor, timer 16 provides power at predefined times. For example, timer 16 may include a timing device 24 (e.g., a clock) and be configured to provide the induction motor with 230 VAC from 6:00 AM to 8:00 PM. During that time period, the induction motor runs, and accordingly, a pump attached to the motor conditions water in the aquatic application. Power provided through timer 16 is also referred to herein as a start signal.

In the exemplary embodiment, motor control system 10 includes a first input terminal 26 configured to couple with a first conductor 28, a second input terminal 30 configured to couple with a second conductor 32, and a third input terminal 34 configured to couple with a ground conductor 36. Terminals 26, 30, and 34 and conductors 28, 32, and 36 couple timer 16 to motor controller 12. For example, first conductor 28 may be a first line conductor, second conductor 32 may be a second line or neutral conductor, and the ground conductor 36 is an earth and/or safety ground. In the exemplary embodiment, control device 14 is coupled to motor controller 12. Although described herein as separate from motor controller 12, control device 14 may also be included within motor controller 12. Control device 14 includes a processing device 40 and at least one input device 42. For example, the at least one input device 42 may include a first button 44, a second button 46, and a third button 48. Although referred to herein as buttons 44, 46, and 48, the at least one input device 42 may include any suitable input device(s) that allows motor control system 10 to function as described herein.

The term processing device as used herein, refers to central processing units, microprocessors, microcontrollers, reduced instruction set circuits (RISC), application specific integrated circuits (ASIC), logic circuits, and any other circuit or processor capable of executing the functions described herein. In the exemplary embodiment, processing device 40 is a mixed signal microprocessor, for example, but not limited to, a programmable system on a chip (PSoC). PSoC is a registered trademark of Cypress Semiconductor Corporation of San Jose, Calif.

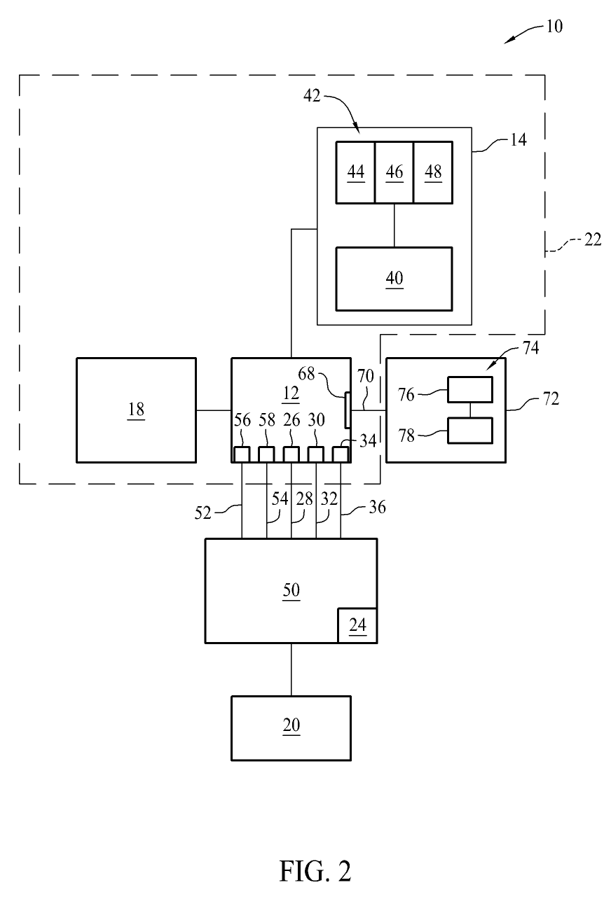

FIG. 2 is a block diagram of motor control system 10 coupled to a multiple-speed induction motor timer 50 (e.g., a two-speed induction motor timer). As described above, the methods and systems described herein facilitate replacing an AC induction motor with motor 18 and operating motor 18 using the same connections used to operate the induction motor. When coupled to an induction motor, two-speed timer 50 provides power at predefined times and also provides speed control signals, for example, at a high speed current output 52 and a low speed current output 54 that control the speed at which the induction motor operates. In the exemplary embodiment, motor controller 12 includes a fourth input terminal 56 configured to couple with high speed current output 52 and a fifth input terminal 58 configured to couple with low speed current output 54.

In some embodiments, motor control system 10 may also include a sixth input terminal 68 configured to couple with at least one conductor 70. Conductor 70 couples motor control system 10 to an external system controller 72. External system controller 72 may also be referred to as an automation controller. External system controller 72 is positioned remote from motor 18 and motor controller 12 and includes, or is coupled to, a user interface 74. User interface 74 includes an input device 76 and a display 78. Input device 76 facilitates receiving user selections and display 78 facilitates viewing of settings and/or selection options by the user. External system controller 72 may provide a speed control signal based on a speed selection entered by a user using input device 76. External system controller 72 provides additional speed control flexibility to the induction motor, and typically also controls operation of other systems within the aquatic application.

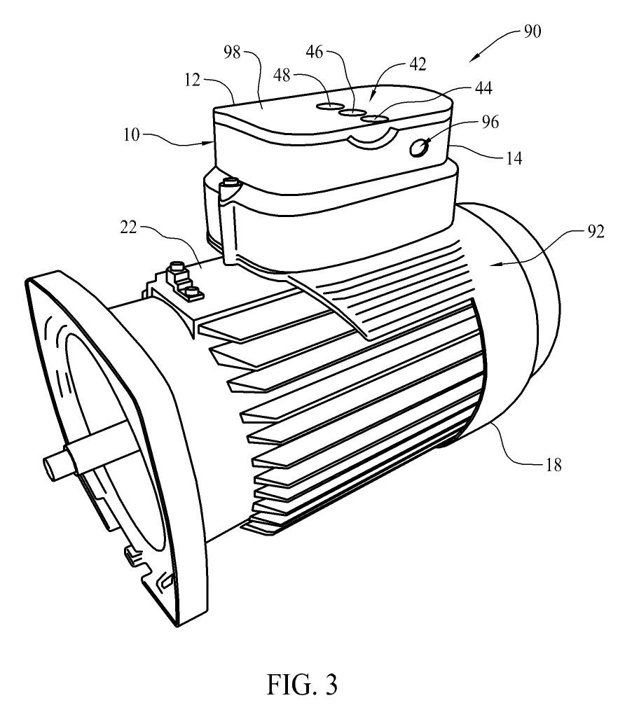

FIG. 3 is a perspective view of an exemplary embodiment of a motor system 90 that includes motor 18 and motor control system 10 (shown in FIGS. 1 and 2). Motor system housing 22 defines an exterior 92 and an interior (not shown in FIG. 3) of motor system 90. In the exemplary embodiment, motor controller 12, control device 14, and motor 18 are at least partially enclosed by housing 22 within the interior of motor system 90. In the exemplary embodiment, housing 22 includes at least a first opening 96. At least one conductor, for example, conductor 28, 32, 36, 52, 54, and/or 70 (shown in FIG. 2), passes from exterior 92 to the interior of motor system 90 for coupling with, for example, a corresponding terminal 26, 30, 34, 56, 58, and/or 68. Furthermore, in the exemplary embodiment, the at least one input device 42 is positioned on an exterior surface 98 of housing 22, is accessible through housing 22, and/or is configured in any other manner that allows a user to access and provide an input selection using the at least one input device 42.

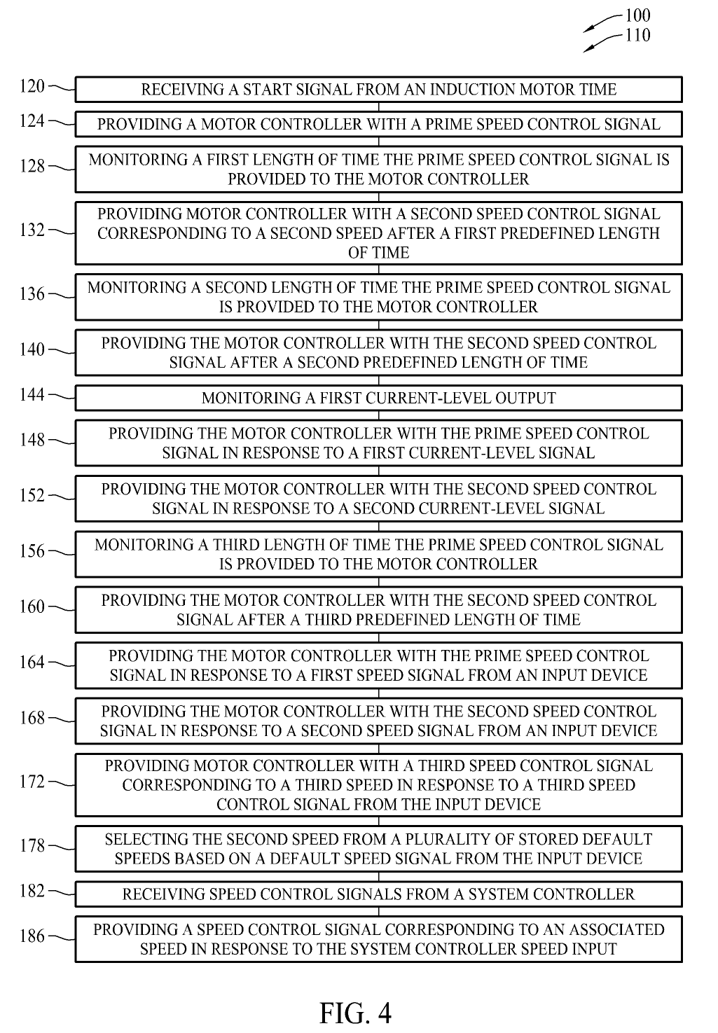

FIG. 4 is a flowchart 100 of an exemplary method 110 for controlling operation of an electronically controlled variable speed motor, for example, motor 18 (shown in FIGS. 1 and 2). In the exemplary embodiment, control device 14, and more specifically, processing device 40 (shown in FIGS. 1 and 2) is programmed to perform method 110. In the exemplary embodiment, method 110 includes receiving 120 a start signal from an induction motor timer, for example, induction motor timer 50 (shown in FIG. 2). Method 110 also includes providing 124 a motor controller, for example, motor controller 12 (shown in FIG. 2) with a first speed control signal in response to the start signal. In the exemplary embodiment, the first speed control signal corresponds to high speed operation of motor 18. Method 110 also includes monitoring 128 a first length of time the first speed control signal is provided to motor controller 12. Control device 14 monitors 128 the length of time motor 18 is operating at high speed in order to ensure that motor 18 operates at high speed long enough to complete a predetermined turn-over operation each time motor 18 starts-up (i.e., priming the motor). Method 110 also includes providing 132 motor controller 12 with a second speed control signal corresponding to a second speed after a first predefined length of time. For example, control device 14 provides 132 the second speed control signal after the predetermined turn-over operation (i.e., after a length of time predetermined to prime a pump).

Control device 14 may provide motor controller 12 with speed control signals (e.g., the first speed control signal or the second speed control signal) on a periodic basis. For example, the period between control device 14 providing the speed control signal may be 0.5 seconds to five seconds, or more specifically, one second to three seconds. Furthermore, control device 14 may provide motor controller 12 with the speed control signals intermittently. Repeatedly sending the speed control signals ensures that motor 18 operates at the speed ordered by control device 14. In other words, repeatedly sending the speed control signals facilitates preventing a speed control signal from a device other than control device 14 from overriding the speed control signal sent by control device 14.

Method 110 may also include monitoring 136 a second length of time the first speed control signal is provided to motor controller 12. Control device 14 begins monitoring 136 the second length of time at the end of the first predefined length of time. Method 110 may also include providing 140 motor controller 12 with the second speed control signal after a second predefined length of time. In a specific example, the second predefined length of time is approximately twenty-four hours. Twenty-four hours is an example only and any suitable time may be used. By monitoring 136 the second length of time, control device 14 ensures that motor 18 does not operate at high speed for longer than the second length of time (e.g., longer than twenty-four hours). As such, no user entered speed control signals will cause motor 18 to operate non-stop at high speed for longer than the second length of time.

Method 110 may also include monitoring 144 a first current-level output, for example, high speed current output 52 (shown in FIG. 2), of induction motor timer 50 and a second current-level output, for example, low speed current output 54 (shown in FIG. 2) of induction motor timer 50. Method 110 also includes providing 148 motor controller 12 with the first speed control signal in response to a first current-level signal from high speed current output or no signals from either high speed current output 52 or low speed current output 54. Method 110 also includes providing 152 motor controller 12 with the second speed control signal in response to a second current-level signal from low speed current output 54.

Method 110 may also include monitoring 156 a third length of time the first speed control signal is provided to motor controller 12. Control device 14 begins monitoring 156 the third length of time beginning at the end of the first predefined length of time. Method 110 also includes providing 160 motor controller 12 with the second speed control signal after a third predefined length of time. The third predefined length of time is greater than the first predefined length of time and less than the second predefined length of time. For example, the third predefined length of time may be in the range of 0.5 hours to four hours, more specifically, one hour to three hours, and even more specifically, approximately two hours. Monitoring 156 the third length of time ensures that motor 18 does not operate at high speed, even if a high speed signal is received from induction motor timer 50, for longer than the third length of time (e.g., two hours). Control device 14 facilitates reducing energy consumption of motor 18 by operating motor 18 at a lower speed after the third predefined length of time.

Method 110 may also include providing 164 motor controller 12 with the first speed control signal in response to a first speed signal from at least one input device, for example, input device 42 (shown in FIG. 2). As described above, first input device 42 may include first, second, and third buttons 44, 46, and 48 (shown in FIG. 2). In some embodiments, first button 44 is labeled “high speed,” second button 46 is labeled “medium speed,” and third button 48 is labeled “low speed.” Control device 14 allows a user to select the speed of operation for motor 18 using input device 42. Accordingly, method 110 also includes providing 168 motor controller 12 with the second speed control signal in response to a second speed signal from third button 48. Method 110 also includes providing 172 motor controller 12 with a third speed control signal corresponding to a third speed in response to a third speed control signal from second button 46. In this embodiment, second speed corresponds to a low motor speed and third speed corresponds to a medium motor speed (e.g., a speed between the low motor speed and the high motor speed).

Method 110 may also include selecting 178 the speed associated with the second speed signal from a plurality of stored default speeds based on a default speed selection signal from input device 42. For example, control device 14 facilitates selection, by a user, of the speed associated with the second speed signal. More specifically, in one specific embodiment, a user is able to select between motor 18 operating at 2600 revolutions per minute (RPM) in response to receiving the second speed control signal, or motor 18 operating at 1725 RPM in response to receiving the second speed control signal. In this example, an example of a high speed may be 3250 RPM. The above speeds are provided as examples only and motor 18 may be directed to operate at any suitable speed required by the application. Processing device 40 may be configured to adjust the second speed based on a default speed selection signal generated in response to a user input provided via at least one of first button 44, second button 46, and/or third button 48. For example, processing device 40 may be configured to switch between a plurality of stored speeds in response to receipt of the default speed selection signal. The default speed selection signal may be recognized by processing device 40 when at least one of the first speed signal, the second speed signal, and the third speed signal is received by processing device 40 for more than a predefined length of time. In other words, if a user presses and holds one of first button 44, second button 46 and/or third button 48, processing device 40 recognizes the speed signal received for longer than the predefined length of time as the default speed selection signal, rather than a request to operate at the speed associated with first button 44, second button 46, or third button 48, and switches between stored values for the second speed.

When motor control system 10 is coupled to system controller 72, method 110 may also include receiving 182 at least one of a first system controller speed input, a second system controller speed input, and a third system controller speed input from system controller 72. System controller 72 is another source of speed control signals. Control device 14 is configured to receive 182 speed control signals from system controller 72 and to provide 186 a speed control signal corresponding to an associated speed in response to the system controller speed input. Control device 14 is also configured such that motor 18 will not operate at high speed for longer than the second length of time, even when system controller 72 is providing a speed control signal directing motor 18 to operate at high speed. By monitoring 136 the second length of time, control device 14 ensures that motor 18 does not operate at high speed for longer than the second length of time (e.g., longer than twenty-four hours). As such, no user entered speed control signals (e.g., signals from timer 50, input device 42, or system controller 72) will cause motor 18 to operate non-stop at high speed for longer than the second length of time.

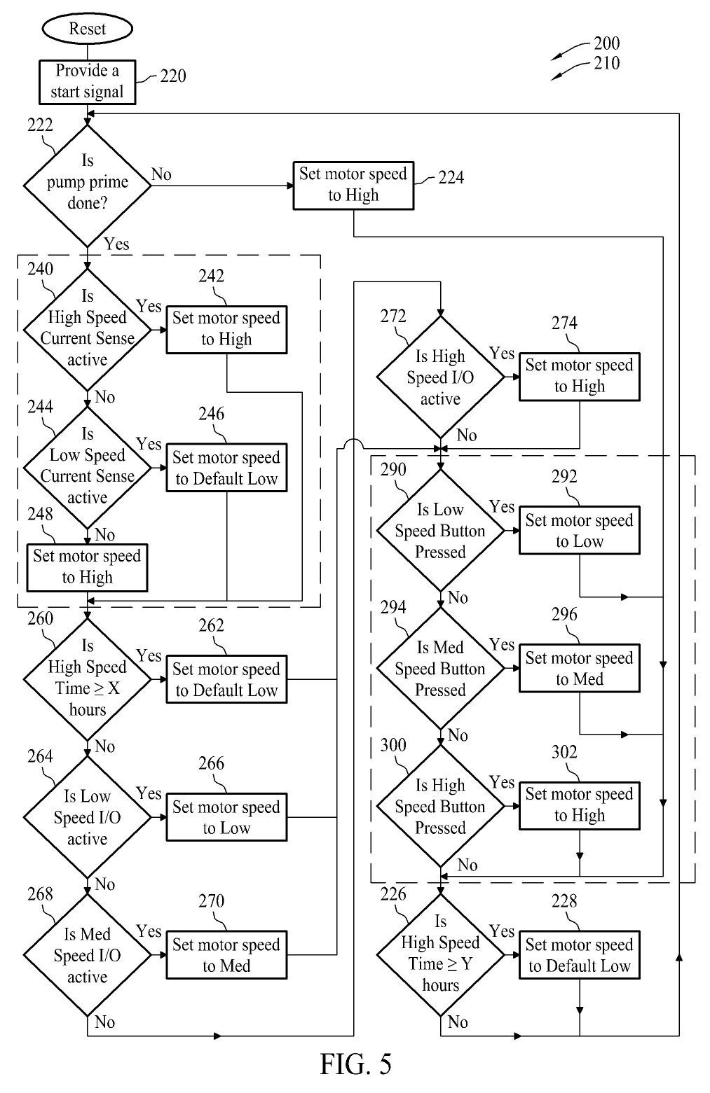

FIG. 5 is a flow chart 200 of an exemplary method 210 performed by a control device, for example, control device 14 (shown in FIGS. 1 and 2) for controlling operation of an electronically controlled variable speed motor, for example, motor 18 (shown in FIGS. 1 and 2). In the exemplary embodiment, an induction motor timer, for example, induction motor timer 50 (shown in FIG. 2) provides 220 a start signal that is received by control device 14. Control device 14 determines 222 if a pump priming operation (e.g., operating motor 18 at a high speed for the first predefined period of time) is complete. If the pump priming operation is not complete, control device 14 provides 224 a motor controller, for example, motor controller 12 (shown in FIGS. 1 and 2) with a first speed control signal, which causes motor 18 to operate at a first, high speed. Control device 14 also determines 226 if motor 18 has operated at the first speed for longer than a second predefined time period (e.g., longer than twenty-four hours). If motor 18 has operated at the first speed for longer than the second predefined time period, control device 14 provides 228 a second speed control signal, which causes motor 18 to operate at a second, lower speed. Control device 14 again determines 222 if the pump priming operation is complete.

If control device 14 determines 222 the pump priming operation is complete, control device 14 determines 240 if a high speed current sense, for example, high speed current output 52 (shown in FIG. 2), is active. If high speed current output 52 is active, control device 14 provides 242 the first speed control signal to motor controller 12. If high speed current output 52 is not active, control device 14 determines 244 if a low speed current sense, for example, low speed current output 54 (shown in FIG. 2), is active. If low speed current output 54 is active, control device 14 provides 246 the second speed control signal to motor controller 12. If high speed current output 52 is not active, and low speed control signal 54 is not active, control device 14 provides 248 the first speed control signal to motor controller 12.

Control device 14 also determines 260 if motor 18 has operated at the high speed for longer than a third length of time (e.g., approximately 2 hours). If motor 18 has been operating at high speed for longer than the third length of time, control device 14 provides 262 the second speed control signal to motor controller 12. If motor 18 has not been operating at high speed for longer than the third length of time, control device 14 determines 264 if a low speed input signal is present from a system controller, for example, system controller 72 (shown in FIG. 2). If system controller 72 is providing a low speed input signal to control device 14, control device 14 provides 266 the second speed control signal to motor controller 12. If system controller 72 is not providing a low speed input signal to control device 14, control device 14 determines 268 if a medium speed input signal is present from system controller 72. If system controller 72 is providing a medium speed input signal to control device 14, control device 14 provides 270 the third speed control signal to motor controller 12 (e.g., a speed control signal corresponding to a speed that is slower than the first speed and faster than the second speed).

If system controller 72 is not providing a medium speed input signal to control device 14, control device 14 determines 272 if a high speed input signal is present from system controller 72. If system controller 72 is providing a high speed input signal to control device 14, control device 14 provides 274 the first speed control signal to motor controller 12.

If control device 14 determines 727 system controller 72 is not providing a high speed input signal to control device 14, control device 14 determines 290 if a low speed input signal is present from input device 42. If input device 42 is providing a low speed input signal to control device 14, control device 14 provides 292 the second speed control signal to motor controller 12. If input device 42 is not providing a low speed input signal to control device 14, control device 14 determines 294 if a medium speed input signal is present from input device 42. If input device 42 is providing a medium speed input signal to control device 14, control device 14 provides 296 the third speed control signal to motor controller 12. If input device 42 is not providing a medium speed input signal to control device 14, control device 14 determines 300 if a high speed input signal is present from input device 42. If input device 42 is providing a high speed input signal to control device 14, control device 14 provides 302 the first speed control signal to motor controller 12.

The methods and systems described herein facilitate automatically reducing a speed of a fluid moving/pumping device to a user selectable lower speed, after a predefined period of time on a higher speed. The period of time is calculated to provide fluid “turn-over” to properly filter or condition the fluid prior to use of the aquatic application. The lower, selected speed is set to provide sufficient fluid flow to maintain proper system operation. Switching from the high speed setting to the lower speed setting is intended to reduce the expenditure of energy. The methods and systems described herein may be incorporated within a motor/motor controller combination. This facilitates controlling the operation of the motor without using a separate energy saving timer or control.

More specifically, the motor control system described herein includes input terminals that facilitate coupling the motor control system to a single-speed timer or to a two-speed timer. The motor control system is configured to control operation of the motor in an energy-saving manner in response to signals from either the single-speed timer or the two-speed timer. Furthermore, the motor control system described herein includes an input terminal that facilitates coupling an external system controller to the motor control system. The motor control system is configured to control operation of the motor in an energy-saving manner even if the external system controller instructs the motor control system to operate in a less energy efficient manner. For example, the motor control system is configured to limit a length of time the motor operates at a high speed irrespective of the speed control signals received from the two-speed timer and/or the external system controller.

Exemplary embodiments of methods and systems are described and/or illustrated herein in detail. The methods and systems are not limited to the specific embodiments described herein, but rather, components of each apparatus, as well as steps of each method, may be utilized independently and separately from other components and steps described herein. Each component, and each method step, can also be used in combination with other components and/or method steps.

When introducing elements/components/etc. of the methods and systems described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A motor control system for controlling an electronically controlled motor based at least partially on a signal from a motor timer, said system comprising:
a motor controller coupled to the electronically controlled motor and configured to drive the electronically controlled motor; and
a control device coupled to the motor controller and configured to:
provide the motor controller with a first speed control signal corresponding to a first speed in response to a start signal from the motor timer;
monitor a first length of time the first speed control signal is provided to the motor controller; and
provide the motor controller with a second speed control signal corresponding to a second speed after a first predefined length of time.

2. A system in accordance with claim 1, wherein the control device is configured to provide the motor controller with one of the first speed control signal and the second speed control signal on at least one of a periodic basis and intermittently.

3. A system in accordance with claim 2, wherein the control device is configured to provide the motor controller with one of the first speed control signal and the second speed control signal between once every 0.5 seconds and once every 3 seconds.

4. A system in accordance with claim 1, wherein the control device is further configured to:
monitor a second length of time the first speed control signal is provided to the motor controller, the second length of time beginning at the end of the first predefined length of time; and
provide the motor controller with the second speed control signal after the second length of time exceeds a second predefined length of time.

5. A system in accordance with claim 4, wherein the second predefined length of time is approximately twenty-four hours.

6. A system in accordance with claim 1, wherein the motor is coupled to a pump, and wherein the first predefined length of time corresponds to a length of time predetermined to prime the pump.

7. A system in accordance with claim 1, wherein the motor timer comprises a two-speed induction motor timer, the control device configured to receive one of a first current-level signal and a second current-level signal from the motor timer and to provide the motor controller with the first speed control signal in response to the first current-level signal and provide the motor controller with the second speed control signal in response to the second current-level signal.

8. A system in accordance with claim 7, wherein the control device is further configured to:
monitor a third length of time the first speed control signal is provided to the motor controller in response to the first current-level signal, the third length of time beginning at the end of the first predefined length of time; and
provide the motor controller with the second speed control signal after the third length of time exceeds a third predefined length of time.

9. A system in accordance with claim 8, wherein the third predefined length of time is from approximately one hour to approximately three hours.

10. A system in accordance with claim 1, wherein the control device comprises a processing device and an input device.

11. A system in accordance with claim 10, wherein the input device comprises at least one of a first speed input, a second speed input, and a third speed input.

12. A system in accordance with claim 11, wherein the processing device is configured to:
provide the motor controller with the first speed control signal in response to a first speed signal from the first speed input;
provide the motor controller with the second speed control signal in response to a second speed signal from the second speed input; and
provide the motor controller with a third speed control signal corresponding to a third speed in response to a third speed signal from the third speed input.

13. A system in accordance with claim 11, wherein the processing device is further configured to adjust the second speed based on a default speed selection signal from at least one of the first speed input, the second speed input, and the third speed input.

14. A system in accordance with claim 13, wherein the processing device recognizes the default speed selection signal after at least one of the first speed signal, the second speed signal, and the third speed signal is received by the processing device for more than a predefined length of time.

15. A system in accordance with claim 11, wherein the processing device switches between a plurality of stored speeds in response to receipt of the default speed selection signal.

16. A system in accordance with claim 1, further comprising a system controller coupled to the control device.

17. A system in accordance with claim 16, wherein the control device is further configured to:
receive at least one of a first system controller speed input, a second system controller speed input, and a third system controller speed input from the system controller; and
provide a speed control signal corresponding to an associated speed in response to the at least one of a first system controller speed input, a second system controller speed input, and a third system controller speed input.

18. A method for controlling operation of an electronically controlled variable speed motor coupled to a motor controller and a control device, the control device including a processing device and at least one input device, wherein the control device is coupled to a motor timer, said method comprising:
receiving, at the control device, a start signal from the motor timer;
providing the motor controller with a first speed control signal in response to the start signal;
monitoring a first length of time the first speed control signal is provided to the motor controller, and
providing the motor controller with a second speed control signal corresponding to a second speed after a first predefined length of time.

19. A method in accordance with claim 18, further comprising providing the motor controller with one of the first speed control signal and the second speed control signal on at least one of a periodic basis and intermittently.

20. A method in accordance with claim 18, wherein providing the motor controller with a second speed control signal comprises providing the second speed control signal after a length of time predetermined to prime a pump.

21. A method in accordance with claim 18, further comprising:
monitoring a second length of time the first speed control signal is provided to the motor controller, the second length of time beginning at the end of the first predefined length of time; and
providing the motor controller with the second speed control signal after a second predefined length of time.

22. A method in accordance with claim 18, further comprising monitoring a first current-level output of the motor timer and a second current-level output of the motor timer.

23. A method in accordance with claim 22, further comprising:
providing the motor controller with the first speed control signal in response to a first current-level signal from first current-level output or no signals from either first current-level output or second current-level output; and
providing the motor controller with the second speed control signal in response to a second current-level signal from the second current-level output.

24. A method in accordance with claim 22, further comprising:
monitoring a third length of time the first speed control signal is provided to the motor controller, the third length of time beginning at the end of the first predefined length of time; and
providing the motor controller with the second speed control signal after a third predefined length of time.

25. A method in accordance with claim 18, further comprising:
providing the motor controller with the first speed control signal in response to a first speed signal from the at least one input device;
providing the motor controller with the second speed control signal in response to a second speed signal from the at least one input device; and
providing the motor controller with a third speed control signal corresponding to a third speed in response to a third speed signal from the at least one input device.

26. A method in accordance with claim 18, further comprising selecting the second speed from a plurality of stored default speeds based on a default speed signal from the at least one input device.

27. A method in accordance with claim 18, wherein a system controller is coupled to the control device, the method further comprising:
receiving at least one of a first system controller speed input, a second system controller speed input, and a third system controller speed input from the system controller; and
providing the a speed control signal corresponding to an associated speed in response to the at least one of a first system controller speed input, a second system controller speed input, and a third system controller speed input.
